(19) United States
(12) Patent Application Publication
(10) Pub. No.: US 2025/0037070 A1
(43) Pub. Date: Jan. 30, 2025

(54) RECOMMENDATIONS BASED ON AGING INVENTORY

(71) Applicant: HONEYWELL INTERNATIONAL INC., Charlotte, NC (US)

(72) Inventors: Varun Singh, Pune (IN); Santosh Balbhadra Trivedi, DUBLIN (IE); Sachin Kulkarni, Bangalore (IN); Kartikeyan Bollapalli, Bangalore (IN); Ankit Parikh, Bangalore (IN)

(21) Appl. No.: 18/227,314

(22) Filed: Jul. 28, 2023

(51) Int. Cl. G06Q 10/087; G06Q 10/0631

(52) U.S. Cl. CPC G06Q 10/087; G06Q 10/06315

(57) ABSTRACT

Techniques for identifying aging inventory and generating recommendations for managing the aging inventory are described. In an example, inventory datasets may be retrieved from a centralized repository, such as an EPCIS repository. An inventory dataset includes at least a unique identifier of a product, hierarchy data between different products, and a status of the product at different instances. The inventory datasets may be analysed to identify aging inventory. The aging inventory include a product inventory for which an expiration date is approaching, a product inventory which has stored in an inventory storage facility beyond a stipulated time, and so on. The aging inventory may be identified based on determination of manufacturing date of the products. Based on the aging inventory, recommendations may be generated for disposal of the aging inventory. The recommendations may be based on a set of rules.

### TECHNICAL FIELD

The present subject matter relates, in general, to inventory management, and in particular but not exclusively, to identification of aging inventory and generation of recommendations for managing the aging inventory.

### BACKGROUND

Inventory management is an important aspect of managing a supply chain. Inventory management refers to tracking inventory from manufacturers to inventory storage facilities and from these facilities to customers. Inventory management ensures that a company or an organization has inventory available to meet customer orders while minimizing any costs that may be associated with holding the inventory or running out of the inventory.

### SUMMARY OF INVENTION

This summary is provided to introduce concepts related to generation of recommendations based on aging inventory. This summary is not intended to identify essential features of the claimed subject matter nor is it intended for use in determining or limiting the scope of the claimed subject matter.

In an aspect of the present subject matter, a method for identifying aging inventory and generating recommendations for managing the aging inventory is disclosed. The method includes obtaining an inventory dataset associated with a plurality of products stored at an inventory storage facility, by a query engine. The inventory storage facility is part of a supply chain. The inventory dataset is stored in a centralized repository. Further, the method includes, parsing the inventory dataset to identify aging inventory stored at the inventory storage facility, by a recommendation engine. Based on the identification, recommendations for handling the aging inventory stored at the inventory storage facility, based on a set of rules are generated by the recommendation engine. In addition, the method includes initiating inventory replenishment to update a product inventory at the inventory storage facility based on at least one of the recommendations and a user input, by the recommendation engine.

In another aspect of the present subject matter, a system for identifying aging inventory and generating recommendations for managing the aging inventory is disclosed. The system includes a processor, a query engine, and a recommendation engine. The query generation engine and the recommendation engine, both are coupled to the processor. The query engine may query a centralized repository to retrieve an inventory dataset associated with a product inventory stored in a plurality of associated inventory storage facilities. The centralized repository stores the inventory dataset in a specific format. Further, the recommendation engine may determine an expiration date of each item in the product inventory stored across all inventory storage facilities, based on the inventory dataset. The recommendation engine may generate recommendations for taking a pre-determined action with respect to the product inventory of the particular product stored across all facilities, based on the expiration date. Thereafter, the recommendation engine may update the inventory dataset in the centralized repository upon receiving a confirmation that the pre-determined action has been taken.

In yet another aspect of the present subject matter, a non-transitory computer-readable medium for identifying aging inventory and generating recommendations for managing the aging inventory is disclosed. The non-transitory computer-readable medium has instructions stored thereon. The instructions, when executed by a processor, cause the processor to perform operations. In the operations, a centralized repository is queried to access a plurality of inventory datasets associated with all products stored at a plurality of inventory storage facilities of multiple supply chains. In response to querying, one or more inventory datasets, from amongst the plurality of inventory datasets, of all products stored at the plurality of inventory storage facilities pertaining to a supply chain are obtained. Further, based on the one or more inventory datasets, an inventory holding period for all the products stored at the plurality of inventory storage facilities is computed. In addition, it is determined if the inventory holding period has exceeded a pre-defined duration, at one or more inventory storage facilities from amongst the plurality of inventory storage facilities. Based on the determination, distribution of the product inventories from the one or more inventory storage facilities is initiated, based on a set of rules.

### BRIEF DESCRIPTION OF FIGURES

Systems and/or methods, in accordance with examples of the present subject matter are now described and with reference to the accompanying figures, in which:

FIG. 1 illustrates a system for identifying aging inventory and generating recommendations for managing the aging inventory, according to an example;

FIG. 2 illustrates a network environment for identifying aging inventory and generating recommendations for managing the aging inventory, according to an example;

FIG. 3 illustrates an exemplary supply chain having multiple inventory storage facilities for receiving recommendations generated based on aging inventory, according to an example;

FIG. 4 depicts an exemplary scenario for assigning hierarchical information to product inventories, according to an example;

FIG. 5 illustrates a method for identifying aging inventory and generating recommendations for managing the aging inventory, according to an example;

FIG. 6 illustrates a method for identifying aging inventory and generating recommendations for managing the aging inventory, according to another example;

FIG. 7 illustrates a method for identifying aging inventory and generating recommendations for managing the aging inventory, according to another example; and

FIG. 8 illustrates a non-transitory computer readable medium for generating identifying aging inventory and generating recommendations for managing the aging inventory, according to an example.

### DETAILED DESCRIPTION

Inventory management plays a vital role in maintaining optimal quantities of product inventories in inventory storage facilities, such as warehouses. The inventory storage facilities are a part of a supply chain. Conventional approaches of inventory management include manual recording of information related to inventories (for example, identification numbers, product manufacturing date, etc.). This information may then be stored in a database for monitoring purposes. However, the conventional approaches for obtaining inventory information have certain limitations. For example, manual recording and processing of the inventory information at a large scale may be prone to error. This may result in inaccurate inventory management. In addition, the conventional approaches, being manual, may be time-consuming and may not be up to date.

For example, usually product inventories are shipped in large quantities, even when a product has a small demand. Thus, most of the product inventories remain unused for a long period of time. By shipping large quantities of products at once, inventory storage facilities may be burdened to store the product inventories that are not needed immediately. As a result, the product inventories may remain stored for too long in some inventory storage facilities. A product inventory that is stocked up in the inventory storage facilities for a long time either due to low-demand or no demand at all may be referred to as aging inventory. In addition, the aging inventory may also include the product inventory for which an expiration date is approaching or has passed. The conventional approaches do not provide any insights about the aging inventory in the inventory storage facilities. As a result, meaningful insights may not be derived from the product inventories managed through conventional approaches.

Further, as demand for product inventories may change over time, because of the manual recording, the conventional approaches may be unable to capture such changes in a timely manner. In absence of real-time information about the changes in the product inventories, the conventional approaches for inventory management become unreliable for managing product inventories associated with the inventory storage facilities spread over multiple locations. Any insights derived based on the conventional approaches for inventory management may lead to ineffective supply chain management, thereby affecting revenues and resources of an enterprise.

The present subject matter provides approaches for generating recommendations for aging inventory. In an example implementation, a centralized repository is queried to retrieve an inventory dataset. The centralized repository may store data in the form of Electronic Product Code Information Services (EPCIS) data. The EPCIS is a global standard for capturing and communicating events for tracking and tracing products within an enterprise and across a supply chain. As may be understood, the EPCIS may store multiple inventory datasets pertaining to different types of inventories associated with the supply chain. Based on the query, the inventory dataset associated with a plurality of products stored at an inventory storage facility may be retrieved. In an example, the inventory dataset may be associated with a product inventory stored in multiple inventory storage facilities. In another example, one or more inventory datasets associated with all products stored at the multiple inventory storage facilities of multiple supply chains may be retrieved from the centralized repository. The inventory dataset of a product may include information pertaining to at least one of a manufacturing of the product, packaging of the product, unique identifier associated with the packaging, association between different packaging, and a status of the product inventory at different instances. Further, examples of the inventory storage facility may include a warehouse, a distribution centre, or any storage location where the product inventories may be stored.

Upon retrieving the inventory dataset, the inventory dataset may be parsed to identify aging inventory stored at the inventory storage facilities. The aging inventory may be considered as a product inventory for which an expiry date is approaching or a product inventory which has been stored at the inventory storage facility beyond a pre-defined duration. In an example implementation, to identify the aging inventory, an expiration date of each item in the product inventory stored across all inventory storage facilities may be determined. If the expiration date is approaching or has passed, the product inventory is considered as aging. In another example implementation, to identify the aging inventory, an inventory holding period for all the products stored at the plurality of inventory storage facilities may be computed. If the inventory holding period has exceeded a pre-defined duration, the product inventory is considered as aging.

Once the aging inventory is identified, the present subject matter describes generating recommendations for handling the aging inventory stored at the inventory storage facility, based on a set of rules. The set of rules may include instructions for taking pre-determined actions with respect to the aging inventory. For example, the actions may include initiating distribution of the product inventories from the one or more inventory storage facilities, initiate inventory replenishment, for product inventories for which the expiration date is approaching dispatching the products using a First Expiry First Out (FIFO) rule, and so on.

Based on the recommendations and a user input, inventory replenishment may be initiated to update the product inventory at the inventory storage facility. In addition, the inventory dataset in the centralized repository may be updated upon receiving a confirmation that the pre-determined action has been taken. Accordingly, the present subject matter provides an efficient and automated technique for identifying aged inventory based on the EPCIS data. The present subject matter thus facilitates in optimizing inventory storage space in one or more inventory storage facilities of the supply chain.

As used hereinafter, the terms “comprises,” “comprising,” “includes,” “including,” “has,” “having” and any other variation thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

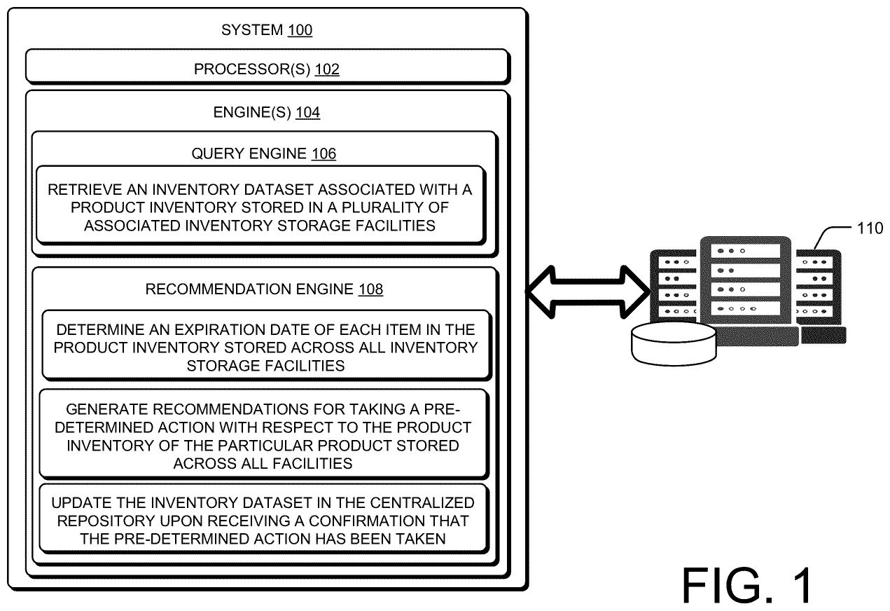

FIG. 1 illustrates a system 100 for generating recommendations for identifying and managing aging inventory, according to an example. Examples of the system 100 may include, but are not limited to, a laptop, a notebook computer, a tablet computer, and a smartphone. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. The system 100 is capable of delivering applications (such as cloud applications) for managing product inventories in a supply chain.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. The engine(s) 104 includes a query engine 106 and a recommendation engine 108.

The aging inventory may refer to low-demand products that sell slowly or do not sell at all. The aging inventory may include product inventory for which the expiration date is approaching or has been passed. In addition, the aging inventory may include the product inventory which has been stored for a long period of time. The product inventory may be one of a raw material, a work in progress item, a finished product, and so on. In an example, the product inventory may include perishable goods, non-perishable goods, consumable goods, non-consumable goods, etc.

In operation, the query engine 106 of the system 100 may obtain an inventory dataset associated with a plurality of products stored at an inventory storage facility. The inventory storage facility may include a warehouse, a manufacturing unit, a distribution centre, or any entity where products associated with a supply chain may be stored. The inventory storage facility is a part of a supply chain. In an example, the query engine 106 may query a centralized repository 110 to obtain the inventory dataset. The centralized repository 110 may be remotely located and may be accessible to all entities associated with the supply chain. The centralized repository 110 may be an Electronic Product Code Information Services (EPCIS) repository. Therefore, data stored in the centralized repository 110 is in accordance with global GS1 Standard for creating and sharing both within and across enterprises. The EPCIS repository captures events associated with various product inventories and stores data pertaining to the events.

In the present implementation, the query engine 106 may query the centralized repository to retrieve the inventory dataset associated with a product inventory. The query engine 106 may query the EPCIS repository through a query interface of the EPCIS repository. For example, the query may be specific to a type or category of product. The inventory dataset may refer to a set of data that may include information pertaining to a product inventory. For example, the information may include manufacturing date of the product inventory, quantity of the product inventory, unique identifier associated with the product inventory, current location(s) of the product inventory, status of the product inventory, hierarchy data of the product inventory, and so on.

Upon retrieval of the inventory dataset, the recommendation engine 108 may determine an expiration date of each item in the product inventory. The product inventory may be associated with a product that may be stored across all inventory storage facilities of the supply chain. In an example, the inventory dataset includes information about the manufacturing date of the items in the product inventory. Based on the manufacturing date, the recommendation engine 108 may determine the expiration date of the product inventory. In another example, the recommendation engine 108 may determine the expiration date of the product inventory from the unique identifier associated with each item of the product inventory. The unique identifier may include indications regarding the expiration date of the product inventory. Details pertaining to the unique identifiers may be provided at later paragraphs of the description.

Once the expiration date is determined, the recommendation engine 108 may generate recommendations for taking a pre-determined action with respect to the product inventory stored across all inventory storage facilities. The generation of recommendations to take pre-determined action may vary based on the expiration date determined by the recommendation engine 108. In a scenario, the recommendation engine 108 may determine if the expiration date of the product inventory is approaching. For example, the expiration date of the product inventory may be falling within a month. In such scenario, the recommendation engine 108 may generate recommendation to distribute the product inventory based on a First-Expiry-First-Out method. Thus, the product inventory for which the expiration date is approaching would be dispatched from the inventory storage facility prior to the remaining product inventories. In another scenario, the expiration date of the product inventory may have passed. In such scenario, the recommendation engine 108 may generate recommendation to discard the product inventory. Further, the recommendation engine 108 may generate alerts for the inventory storage facilities to inform about the expiration date of the product inventories stored in respective inventory storage facilities.

Thus, the present subject matter utilizes EPCIS data to manage or monitor the aging inventory in an efficient manner. By generating alerts and recommendations, the present subject matter facilitates identifying and disposing of the aging inventory. This allows efficient management of space in the inventory storage facilities. In addition, managing the aging inventory facilitates improving profitability and reducing wastage of the inventory.

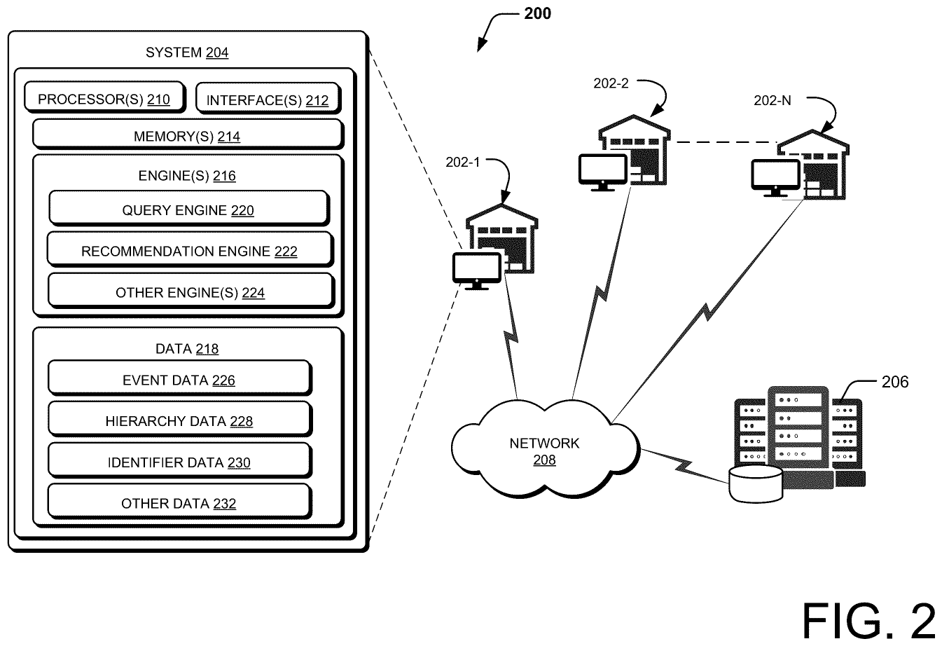

FIG. 2 illustrates a network environment 200 for identifying aging inventory and generating recommendations for managing the aging inventory, according to an example. The network environment 200 includes a plurality of inventory storage facilities 202-1, 202-2, . . . 202-N, collectively referred to as the inventory storage facilities 202 and individually referred to as the inventory storage facility 202. Each of the inventory storage facilities 202 may include a system 204 for identifying aging inventory and generating recommendations for managing the aging inventory. The system 204 is similar to the system 100.

Further, the network environment 200 may include a centralized repository 206 accessible to the inventory storage facilities 202 through a network 208. The centralized repository 206 may be an Electronic Product Code Information Services (EPCIS) repository. Therefore, data stored in the centralized repository 206 is in accordance with global GS1 Standard for creating and sharing both within and across enterprises. The EPCIS repository 206 captures events associated with various product inventories and stores data pertaining to the events. Much of the data provided by EPCIS repository 206 consists of events, such as observations of a product in particular locations within the premises of an enterprise, as well as actions performed on the product, e.g., packing, unpacking, shipping, and receiving. The EPCIS repository 206 may also include other attributes and sensor measurements associated with the product or its environment, e.g., price, quality, temperature, and humidity.

Further, the network 208 may be a wireless network, a wired network, or a combination thereof. The network 208 can also be an individual network or a collection of many such individual networks, interconnected with each other and functioning as a single large network, e.g., the Internet or an intranet. The network 208 can be implemented as one of the different types of networks, such as intranet, local area network (LAN), wide area network (WAN), the internet, and such. The network 208 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the network environment 200 can be a company network, including thousands of office personal computers, laptops, various servers, such as blade servers, and other computing devices connected over the network 208. The system 204 includes processor(s) 210 similar to the processor(s) 102. Further, the system 204 includes interface(s) 212 and memory(s) 214. The interface(s) 212 may allow the connection or coupling of the system 204 with one or more other devices, through a wired (e.g., Local Area Network, i.e., LAN) connection or through a wireless connection (e.g., Bluetooth®, Wi-Fi). The interface(s) 212 may also enable intercommunication between different logical as well as hardware components of the system 204.

The memory(s) 214 may be a computer-readable medium, examples of which include volatile memory (e.g., RAM), and/or non-volatile memory (e.g., Erasable Programmable read-only memory, i.e., EPROM, flash memory, etc.). The memory(s) 214 may be an external memory, or internal memory, such as a flash drive, a compact disk drive, an external hard disk drive, or the like. The memory(s) 214 may further include data which either may be utilized or generated during the operation of the system 204.

The system 204 may further include engine(s) 216 and data 218. The engine(s) 2146 includes a query engine 220, a recommendation engine 222, and other engine(s) 224. The other engine(s) 224 may further implement functionalities that supplement functions performed by the system 204 or any of the engine(s) 216. The data 218, on the other hand, includes data that is either stored or generated as a result of functions implemented by any of the engine(s) 216 or the system 204. It may be further noted that information stored and available in the data 218 may be utilized by the engine(s) 216 for performing various functions by the system 204. In an example, the data 218 may include event data 226, hierarchy data 228, identifier data 230, and other data 232. It may be noted that such examples are only indicative. The present approaches may be applicable to other examples without deviating from the scope of the present subject matter.

The present subject matter leverages data stored in the EPCIS repository 206 to perform aging analytics and recommend an appropriate course of action for the users. The EPCIS repository 206 stores data in a specific format, for example, as per global GS1 standard. The global standard associates a unique identification number (EPC) with the data, which is used to retrieve information associated with the product in the supply chain.

In operation, the query engine 220 may perform a query on the centralized repository 206 to retrieve an inventory dataset associated with a product inventory stored in a plurality of associated inventory storage facilities. In an example, the query may be performed through an EPCIS query interface (not shown) of the EPCIS repository 206. Through the interface(s) 212, the user may request information about a specific product and the query will be initiated via the EPCIS query interface. The EPCIS query interface may then interact with upper layer applications, to extract the information about the specific product. The EPCIS query interface facilitates in retrieval of the inventory dataset stored within the EPCIS repository 206. An inventory storage facility may be understood as a warehouse, a manufacturing unit, and a distribution unit associated with the supply chain. The inventory storage facilities are configured to store product inventories before distribution or movement of the product inventories.

The inventory dataset may include information pertaining to the status of the product inventory at different instances. For example, upon occurrence of an event the status of the product inventory may change, and this change is captured by the inventory dataset stored in the EPCIS repository. Examples of the events may include, but are not limited to packaging of a product, dispatch of the product from manufacturing unit, arrival of the product at a warehouse, and so on. The information pertaining to the events may be stored as the event data 226. Further, the inventory dataset may include hierarchical information of the products linked to each other in a parent-child relation such that the unique identifier of a parent product is linked to the unique identifiers of one or more child products associated with the parent product. The hierarchical information is stored as the hierarchy data 228. In addition, the inventory dataset may include information about the unique identifier associated with each inventory item of the inventory storage facility. In an example, the unique identifier may be in the form of a quick response (QR) code or a barcode. The unique identifier may be in accordance with the norms of GS1 and may include multiple identifiers such as an identifier (01) for Global Trade Identification Number (GTIN), an identifier (21) for serial number, an identifier (17) for expiry date, and an identifier (10) for batch number. The information about the unique identifier is stored as the identifier data 230.

In an example implementation, the inventory dataset retrieved by the query engine 220 may be related to a target product. Accordingly, the query engine 220 may frame specific queries to the EPCIS repository to retrieve only such inventory dataset that pertains to the target product. Further, the inventory dataset may include information for the target product from all inventory storage facilities associated with a supply chain. For example, if the supply chain includes 8 warehouses and the query is performed for the target product “FANS”, the inventory dataset may include information pertaining to the product inventories of “FANS” stored at all 8 warehouses. Thus, information pertaining to specific products may be retrieved from the centralized repository 206 and analyzed further to identify aging inventory.

The recommendation engine 222 may analyze the inventory dataset retrieved by the query engine 220. For example, the recommendation engine 222 may determine an expiration date of each item in the product inventory stored across all inventory storage facilities. Referring again to the earlier example, the expiration dates of “FANS” stored in all 8 warehouses are obtained. Although the products packed together are assumed to have the same expiration date, the recommendation engine 222 may analyze the expiration dates of all products, nevertheless. In case the expiration date is not listed in the unique identifier, the recommendation engine 222 may determine the expiration date based on the manufacturing date of the product.

The recommendation engine 222 may compute an age of the product inventory based on the expiration date. For example, the recommendation engine 222 may determine how much time is left before the expiration date is reached. Based on the determination, the recommendation engine 222 may generate alerts for each inventory storage facility of the supply chain to indicate aging inventory at the respective inventory storage facility. A manager of the inventory storage facility may obtain recommendations from the recommendation engine 222 regarding the aging inventory or may employ other techniques to dispose of the aging inventory.

In an example implementation, based on the expiration date, the recommendation engine 222 may also generate recommendations for taking a pre-determined action with respect to the product inventory of the product stored across all inventory storage facilities. For example, the recommendation engine 222 may determine if the expiration date of the product inventory has been crossed. In such a case, the recommendation engine 222 may generate alerts for each of the inventory storage facilities to either discard the product inventory or to sell it at a discounted price.

In an example, the recommendation engine 222 may determine if the expiration date of the product inventory is approaching. In such a case, the recommendation engine 222 may generate recommendation to distribute the product inventory based on a First Expiry First Out (FEFO) method. Under this method, the product or batch with the earliest expiration date is moved to stores first, to avoid obsolescence of the product or batch. Thus, by managing the product inventory based on the FEFO method ensures that each product being sold is well within the expiration date, is fresh, and fit for consumption. FEFO method also facilitates avoiding any labor costs and efforts associated with inspection and checking of expiration dates, which could be tedious and time-consuming.

In an example, the recommendation to distribute the product inventory may include distributing the about to be expired product inventory to those warehouses in the supply chain, where there is more demand for the product inventory. This way, the about to be expired product inventory may be circulated amongst different inventory storage facilities and may be consumed in an efficient manner.

Once the recommendation engine 222 receives a confirmation that the pre-determined action has been taken by the user or manager of the inventory storage facility, the recommendation engine 222 may update the inventory dataset in the centralized repository 206. For example, the recommendation engine 222 may initiate inventory replenishment to update the product inventory at the inventory storage facility based on at least one of the recommendations and a user input. Replenishment of the inventory may include determining which product inventory to be dispatched to which location or inventory storage facility.

The present subject matter therefore facilitates deriving actionable insights from the data stored in the EPCIS repository. By early identifying the aging inventory, the present subject matter facilitates optimizing a cost associated with the supply chain. The recommendation engine 222 may provide automatic and real-time recommendations for product inventories associated with multiple inventory storage facilities, such as warehouses, which are part of the supply chain. As the present subject matter leverages the data stored in the EPCIS repository, additional infrastructure and workforce cost is not incurred.

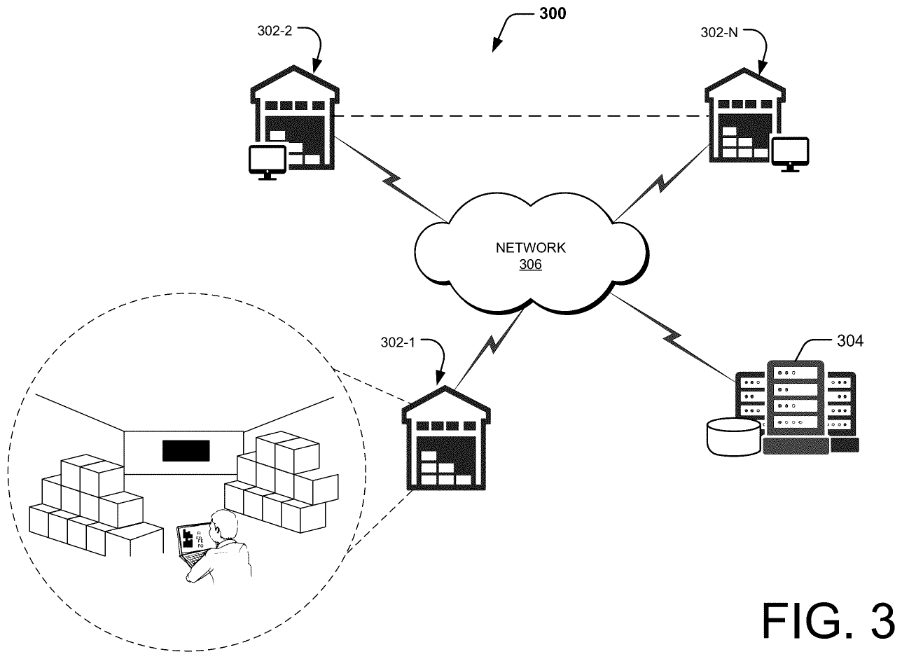

FIG. 3 illustrates an exemplary supply chain 300 having multiple inventory storage facilities for receiving recommendations generated based on aging inventory, according to an example. In an example implementation, the supply chain 300 may include a plurality of inventory storage facilities 302-1, 302-2, . . . 302-N, collectively referred to as the inventory storage facilities 302 and individually referred to as the inventory storage facility 302. Examples of the inventory storage facilities 302 may include, but are not limited to, warehouses, distribution centers, manufacturing units, and third-party logistics. Each inventory storage facility 302 may include equipments, like pallets for storage of products, machinery for moving the products from one place to another, to handle and store the products in a planned space.

Further, the inventory storage facilities 302 of the supply chain 300 may be communicatively coupled to a centralized repository 304. The centralized repository 304 may store data pertaining to all products which are stocked in the inventory storage facilities 302. In a preferred embodiment, the centralized repository 304 is an EPCIS repository. The EPCIS repository may store information pertaining to multiple products in a hierarchical manner. For example, the EPCIS repository may store a unique identifier associated with one pallet. This unique identifier may refer to multiple cases that are packed in the pallet. Further, each case is provided with a separate unique identifier which refers to various bundles packed together in one case. Likewise, every bundle is associated with a different unique identifier to reflect on the multiple primary packs included in the bundle. The centralized repository 304 may be remotely located and may be accessible to the plurality of inventory storage facilities 302 through a network 306.

Users, such as a manager of the inventory storage facility 302 may employ a system 308, similar to the system 204, to obtain recommendations pertaining to the aging inventory. For example, the manager of each warehouse may run a query through the query interface of the centralized repository 304 to identify aging inventory in the warehouse and to obtain recommendations to manage the aging inventory. For example, the user may run a query to obtain inventory dataset from the EPCIS repository. In an example, the query may specify whether the inventory dataset is to be retrieved for a specific product that may be stored across the inventory storage facilities 302, all products that may be stored at a particular inventory storage facility 302, or all products that may be stored at all inventory storage facilities 302 of one supply chain. Based on the query, the system may retrieve the inventory dataset from the centralized repository 304. The inventory dataset may include information such as unique identifiers associated with each product, hierarchical information, and a status information with respect to movement or disposal of the product.

In an implementation, the unique identifiers associated with individual products, a bundle, a case or a pallet may include information pertaining to manufacturing or expiration date of the products. For example, the information pertaining to manufacturing or expiration date of the products may be embedded in the unique identifier of the product. The system 308 may generate a report based on analysis of the inventory dataset retrieved from the centralized repository 304. For example, the system may determine an age of the product inventory pertaining to the inventory dataset. Further, the system may determine whether the expiration date of the product inventory is approaching, or the expiration date of the product inventory has passed. The product inventory for which the expiration date is approaching, or the expiration date has passed is referred to as aging inventory. The aging inventory may also include such product inventories which have been stocked in the inventory storage facilities 302 for a long time.

In an example, if the query is performed to retrieve the inventory dataset pertaining to all products that may be stored at all inventory storage facilities 302 of one supply chain, the system 308 may generate the report to provide details about the product inventory, the expiration date, the inventory storage facility 302 at which the aging inventory is stored, and so on. The report may also indicate reasons for classification of the product inventory as the aging inventory. Examples of the reasons may include, expiration date approaching, expiration date passed, or product inventory stored for a long period of time.

Further, the system 308 may generate recommendations for each type of aging inventory. In an example, the recommendations may be provided as alerts in respective inventory storage facility 302 where the aging inventory is stored. In another example, the recommendations may be provided as suggestions or instructions to dispose of the aging inventory. In a scenario where the aging inventory indicates the product inventory which is low in demand and is stored in the warehouse for a long time, such as more than three months, the recommendations may include instructions for consumption and dispatch prioritization based on age of the product inventory. Specifically, the recommendations may include instructions to dispose the aging inventory using a First In First Out (FIFO) rule. The recommendations may also include instructions to distribute the aging inventory to those warehouses where the demand for the aging inventory is more. In addition, the recommendations may also include suggestions to sell the aging inventory on discounted values.

In another scenario where the aging inventory indicates the product inventory for which the expiration date is approaching, the recommendations may include instructions to dispose the aging inventory using a First Expiry First Out (FEFO) rule. The recommendations may also include instructions to distribute the aging inventory to those warehouses where the demand for the aging inventory is more. In addition, the recommendations may also include suggestions to sell the aging inventory on discounted values. Based on the recommendations, the user may decide an action to be taken on the aging inventory.

Thus, the present subject matter performs aging analysis of product inventories based on the EPCIS data captured automatically in the supply chain. Therefore, the present subject matter provides accurate information about the aging inventory.

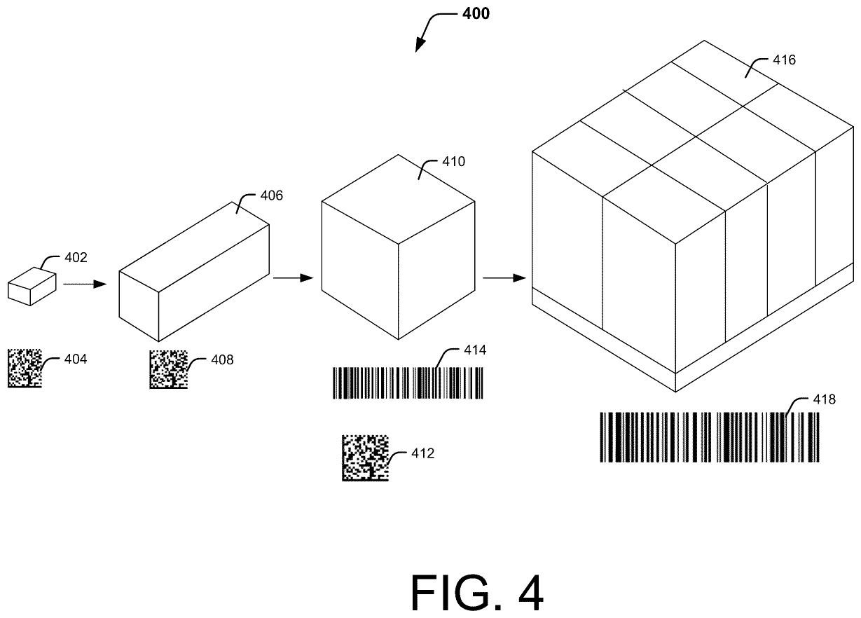

FIG. 4 depicts a scenario 400 in which hierarchical information is assigned to product inventories, according to an example. As depicted in FIG. 4, the product inventory may be broken down into multiple individual items also referred to as primary packs 402. As the information pertaining to the product inventories of the supply chain are being captured and stored in the EPCIS repository, each item in the product inventory may be associated with a unique identifier. For example, the primary pack 402 may be associated with a quick response (QR) code 404. The QR code 404 may include information unique or specific to the single item or primary pack 402. The QR code 404 may be generated as per GS1 data matrix. The GS1 data matrix may include multiple identifiers such as an identifier (01) for Global Trade Identification Number (GTIN), an identifier (21) for serial number, an identifier (17) for expiry date, and an identifier (10) for batch number.

Further, the individual items or primary packs 402 of the product inventory may be packed into bundles 406. For example, one bundle 406 may include multiple primary packs 402. Thus, a bundle 406 may be considered as a parent product of the multiple child products (primary packs 402). If the product inventory includes medicines, the primary pack 402 may include one strip of tablets or capsules and the bundle 406 may include ten or hundred strips of tablets or capsules. In an implementation, the bundle 406 may be associated with a unique aggregate identifier 408. For example, the bundle 406 may be associated with a QR code 408. As the QR code 408 of the bundle 406 may be associated with information pertaining to all primary packs included in the bundle 406, the unique identifier is referred to as the aggregate unique. Thus, based on the unique identifier of the bundle 406, number of primary packs and information related to the primary packs may be obtained. In the present implementation, the QR code 408 may be similar to QR code 404 and may include identifiers associated with GTIN, serial number, expiry date, and batch number of the primary packs included in the bundle 406.

Further, multiple bundles 406 may be packed together to form a case or tertiary pack 410. The case 410 may be associated with one or more unique aggregate identifiers. Thus, a case 410 may be considered as a parent product of the multiple bundles 406. For example, the case 410 may be associated with a QR code 412 and a barcode 414. The QR code 412 may be similar to QR codes 404 and 408 and may include identifiers associated with GTIN, serial number, expiry date, and batch number of the bundles included in the case 410. Further, the barcode 414 may be generated as per GS1-128 standard. The barcode 414 generated as per GS1-128 is a shipping label used for visibility of cases 410 throughout the supply chain. The barcode 414 uses a series of GS1 identifiers to include a range of additional data such as best before date, batch number, quantity, and weight of the case 410.

Finally, multiple cases are packed in one pallet 416. The pallet 416 may be a transport structure that acts as a stable surface for storing and supporting the products. The pallet 416 may be associated with a unique identifier 418. As the pallet 416 may include a plurality of cases, the unique identifier 418 of the pallet 416 may be an aggregate identifier and may include information about the plurality of cases. Unlike the cases or tertiary pack, the pallet 416 may be associated with a single unique identifier in the form of a barcode. Thus, a pallet 416 may be considered as a parent product of the multiple cases 410.

The unique identifier of the pallet 416 may include information pertaining to the multiple tertiary packs or cases included in the pallet 416. The unique identifiers of the case 410 may include information pertaining to the multiple bundles included in the case 410. Likewise, the unique identifier of the bundle 406 may include information pertaining to the multiple primary packs included in the bundle 406. The information about the unique identifiers is stored in the centralized repository, such as EPCIS repository, as inventory datasets. Therefore, the inventory dataset may include hierarchical information of the products linked to each other in a parent-child relation such that the unique identifier of a parent product is linked to the unique identifiers of one or more child products associated with the parent product.

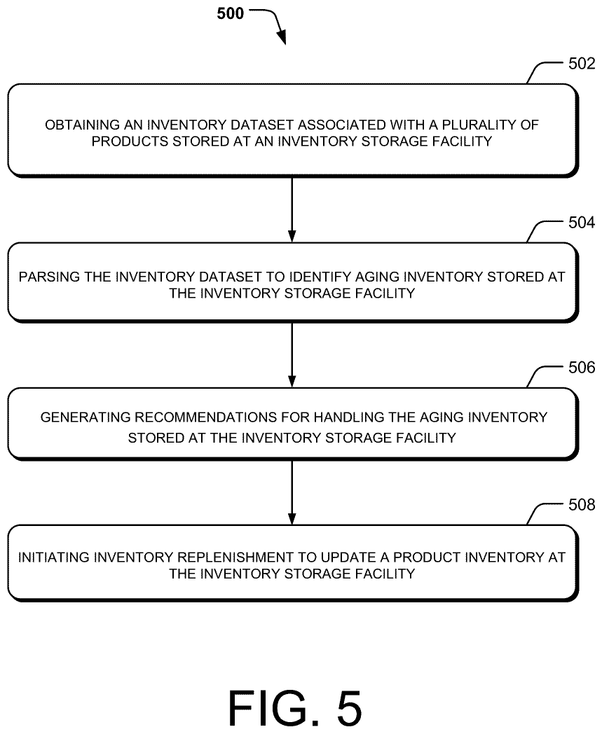

FIGS. 5, 6, and 7 illustrate methods 500, 600, and 700 for generating recommendations for identifying and managing aging inventory, according to an example. The order in which the above-mentioned methods are described is not intended to be construed as a limitation, and some of the described method blocks may be combined in a different order to implement the method, or an alternative method.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where said instructions perform some or all the steps of the above-mentioned methods.

Referring to FIG. 5, the method 500 may be implemented by a system for identifying aging inventory and generating recommendations for managing the aging inventory. At block 502, the method includes obtaining an inventory dataset associated with a plurality of products stored at an inventory storage facility. The inventory storage facility includes equipments, like pallets for storage of products, machinery for moving the products from one place to another, to handle and store the products in a planned space. The inventory storage facility thus enables effective distribution of the products to an intended destination. Examples of the inventory storage facility may include a warehouse, a distribution center, and so on. The inventory storage facility is part of a supply chain. In an implementation, the inventory dataset is obtained by the query engine by querying a centralized repository, such as an Electronic Product Code Information Services (EPCIS) repository.

In the present implementation, the inventory dataset for all products stored at one warehouse or one inventory storage facility is obtained and parsed. For example, if the supply chain includes seven warehouses, the inventory dataset for all products stored at one of the seven warehouses is parsed. Thus, the query may be performed by a user associated with the warehouse, such as a manager of the warehouse.

At block 504, the method 500 includes parsing the inventory dataset to identify the aging inventory stored at the inventory storage facility. The aging inventory may include product inventory for which the expiration date is approaching or has been passed. For example, the parsing may include analyzing the inventory dataset and determining manufacturing date for different product inventories stored at the inventory storage facility. Based on the manufacturing date, an expiration date for the product inventories may be determined. The expiration date may indicate whether a product inventory is aging or not. The aging inventory may also include the product inventory which has been stored at the inventory storage facility beyond a pre-defined duration. For example, the parsing may include analyzing the inventory dataset and determining date of receiving different product inventories at the inventory storage facility. Based on the date of receiving, a duration of storage of the product inventories may be determined. In an example, the recommendation engine may parse the product inventory.

Further, at block 506, the method 500 includes generating recommendations for handling the aging inventory stored at the inventory storage facility. The recommendations may be based on a set of rules. For example, the recommendations may include for the product inventory for which the expiration date is approaching, dispose the aging inventory as per First-Expiry-First-Out rule. In another example, the recommendations may include for the product inventory which has been stored beyond a pre-defined duration, disposing the aging inventory as per First-In-First-Out rule. The recommendations may also include inventory optimization recommendations. In an implementation, the recommendations may be generated by the recommendation engine.

At block 508, the method 500 may include initiating inventory replenishment to update the product inventory at the inventory storage facility based on at least one of the recommendations and a user input. In an example, based on the recommendation, the user, such as the manager of the warehouse, may provide instructions to initiate inventory replenishment to update the product inventory at the inventory storage facility. In an implementation, the recommendation engine may initiate the replenishment of the inventory.

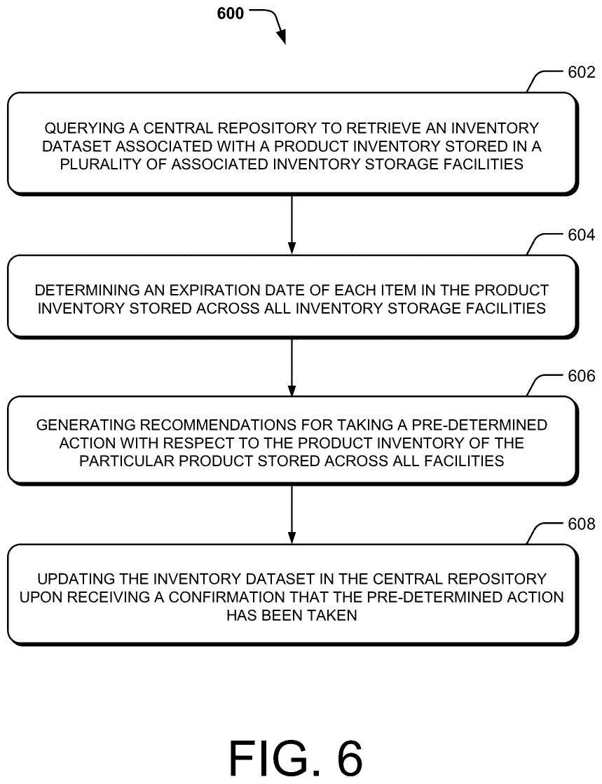

Referring now to FIG. 6, at block 602, the method 600 includes querying a centralized repository to retrieve an inventory dataset associated with a product inventory stored in a plurality of associated inventory storage facilities. The inventory dataset may include a unique identifier associated with each item of the product inventory that may be stored in the inventory storage facility. For example, the unique identifier may be a barcode which may be scanned to obtain details pertaining to the product inventory. The unique identifier of a parent product is linked to unique identifiers of one or more child products associated with the parent product. In an example, the centralized repository may store the inventory dataset in a specific format. In an implementation, a query engine may query the centralized repository to obtain the inventory dataset.

At block 604, the method 600 may include determining an expiration date of each item in the product inventory stored across all inventory storage facilities. For example, the inventory dataset may pertain to canned food items. Based on the unique identifiers associated with each item of the product inventory, the inventory dataset may indicate a manufacturing or packaging date for the canned food items. Using the manufacturing or packaging date, the expiration date for the product inventory may be determined. The expiration date of the product inventory is utilized to compute an age of the product inventory. In an implementation, the recommendation engine may determine the expiration date of the product inventory.

Further, at block 606, the method 600 may include generating recommendations, based on the expiration date, for taking pre-determined actions with respect to the aging inventory. For example, the pre-determined actions may include initiating distribution of the product inventories from the one or more inventory storage facilities, initiate inventory replenishment, for product inventories for which the expiration date is approaching dispatching the products using a First Expiry First Out rule, and so on. In an implementation, the recommendation engine may generate recommendations for taking pre-determined actions with respect to the aging inventory.

At block 608, the method 600 may include updating the inventory dataset in the centralized repository upon receiving a confirmation that the pre-defined action has been taken. For example, the recommendation engine may automatically update a current status of the product inventory in the centralized repository. Accordingly, the present subject matter provides an efficient and automated technique for identifying expired inventory based on the EPCIS data.

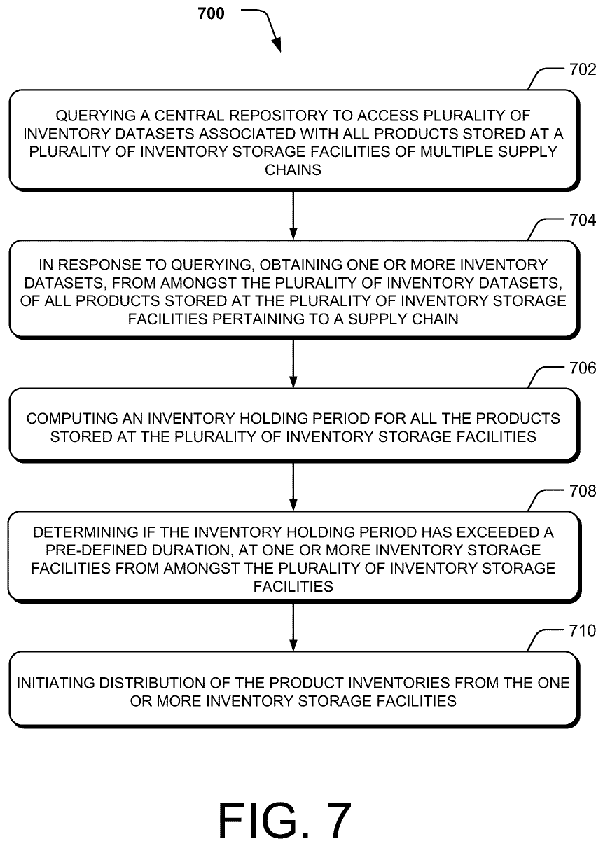

Referring now to FIG. 7, the method 700 may include querying a centralized repository to access plurality of inventory datasets associated with all products stored at a plurality of inventory storage facilities of multiple supply chains. In an implementation, the query engine may query the centralized repository. The centralized repository may be the EPCIS repository. Therefore, the query engine may use a query interface of the EPCIS repository to access the plurality of inventory datasets.

At block 704, the method 700 may include obtaining one or more inventory datasets of all products stored at the plurality of inventory storage facilities pertaining to a supply chain. The inventory dataset includes information pertaining to at least one of a manufacturing of the product, packaging of the product, unique identifier associated with the packaging, association between different packaging, and a status of the product inventory at different instances. Thus, information of product inventories associated with one supply chain is obtained by the query engine.

At block 706, the method 700 may include computing an inventory holding period for all products stored at the plurality of inventory storage facilities.

At block 708, the method 700 may include determining if the inventory holding period has exceeded a pre-defined duration, at one or more inventory storage facilities from amongst the plurality of inventory storage facilities.

At block 710, the method 700 may include initiating distribution of the product inventories from the one or more inventory storage facilities, based on a set of rules. For example, when it is determined that certain product inventories are stored beyond the inventory holding period, the recommendation engine may initiate distribution of the product inventories based on First-In-First-Out rule. In another example, the recommendation engine may prompt a user to initiate distribution of the product based on an expiry date of the product inventory.

The present subject matter therefore facilitates improving profitability and reducing wastage of the aging inventory. As a result, storage space in the inventory storage facilities may be effectively managed.

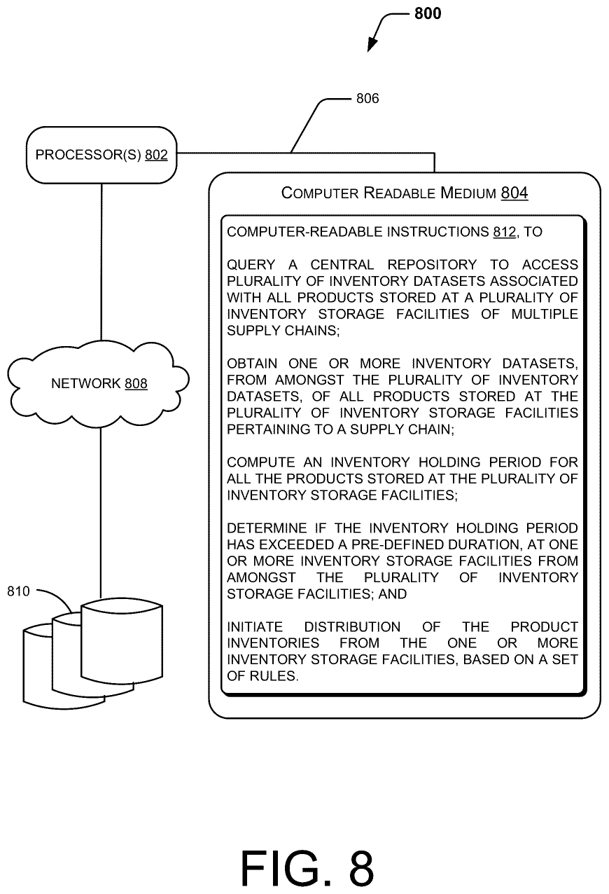

FIG. 8 illustrates a system environment 800 implementing a non-transitory computer readable medium for generating recommendations for identifying and managing aging inventory, according to an example. In an example, the system environment 800 includes processor(s) 802 communicatively coupled to a non-transitory computer readable medium 804 through a communication link 806. In an example, the processor(s) 802 may have one or more processing resources for fetching and executing computer-readable instructions from the non-transitory computer readable medium 804. The processor(s) 802 and the non-transitory computer readable medium 804 may be implemented, for example, in the system 100 (as has been described in conjunction with the preceding figures).

The non-transitory computer readable medium 804 may be, for example, an internal memory device or an external memory device. In an example implementation, the communication link 806 may be a network communication link. The processor(s) 802 may access the non-transitory computer-readable medium 804 through a network 808. The network 808 may be a single network or a combination of multiple networks and may use a variety of communication protocols. The processor(s) 802 and the non-transitory computer readable medium 804 may also be communicatively coupled to a data source 810 over the network 808. The data source 810 may include, for example, a database.

In an example implementation, the non-transitory computer readable medium 804 includes a set of computer readable instructions (hereinafter also referred to as instructions) 812 which may be accessed by the processor(s) 802 through the communication link 806. Referring to FIG. 8, in an example, the non-transitory computer readable medium 804 includes instructions 812 that cause the processor(s) 802 to query a centralized repository to access plurality of inventory datasets associated with all products stored at a plurality of inventory storage facilities of multiple supply chains. In an example, the processor 802 may query the centralized repository. The centralized repository may store data in the form of Electronic Product Code Information Services (EPCIS) data. The EPCIS is a global standard for capturing and communicating events for tracking and tracing products within an enterprise and across a supply chain. The inventory dataset of a product may include information pertaining to at least one of a manufacturing of the product, packaging of the product, unique identifier associated with the packaging, association between different packaging, and a status of the product inventory at different instances. Further, an inventory storage facility may include a warehouse, a manufacturing unit, a distribution centre, or any entity where products are stored.

Further, the instructions 812 cause the processor(s) 802, to obtain one or more inventory datasets from amongst the plurality of inventory datasets, of all products stored at the plurality of inventory storage facilities pertaining to one supply chain. For example, as the centralized repository stores data pertaining to all supply chains, the processor 802 may obtain inventory datasets of one supply chain for which aging inventory is to be monitored. Thereafter, the instructions 812 cause the processor(s) 802 to compute an inventory holding period for all the products stored at the plurality of inventory storage facilities. The inventory holding period may indicate a number of days for which an entity may hold the inventory before the disposing the inventory. For example, the processor 802 may compute the inventory holding period based on the information associated with the inventory dataset obtained from the centralized repository. The inventory dataset may include information pertaining to date and time on which the product inventory was received at the inventory storage facility. Using this information, the processor 802 may compute the number of days for which the product inventory is stocked or stored at the inventory storage facility.

Further, the instructions 812 cause the processor(s) 802, to determine if the inventory holding period has exceeded a pre-defined duration, at one or more inventory storage facilities from amongst the plurality of inventory storage facilities. The product inventories for which the inventory holding period has exceeded the pre-defined duration may be referred to as aging inventory. Considering a scenario where one supply chain has about 7 warehouses. The processor 802 may determine that inventory holding period of few product inventories has exceeded a pre-defined duration, such as 45 days, in 3 warehouses. Further, the instructions 812 cause the processor(s) 802, to initiate distribution of the product inventories from the one or more inventory storage facilities, based on a set of rules. In an example, the processor 802 may initiate distribution of the aging inventories based on a First-In-First-Out rule. In another example, the processor 802 may recommend providing discounts on the product inventories for which the inventory holding period has exceeded. The present subject matter therefore provides an efficient and automated technique for identifying aged inventory based on the EPCIS data. The recommendations for disposal of the aging inventory may facilitate efficient management of space in the inventory storage facilities.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A method comprising:
obtaining, by a query engine, an inventory dataset associated with a plurality of products stored at an inventory storage facility, wherein the inventory storage facility is part of a supply chain, and wherein the inventory dataset is stored in a centralized repository;
parsing, by a recommendation engine, the inventory dataset to identify aging inventory stored at the inventory storage facility;
based on the identification, generating, by the recommendation engine, recommendations for handling the aging inventory stored at the inventory storage facility, based on a set of rules; and
initiating, by the recommendation engine, inventory replenishment to update a product inventory at the inventory storage facility based on at least one of the recommendations and a user input.

2. The method as claimed in claim 1, wherein a plurality of inventory datasets is stored in the centralized repository as an Electronic Product Code Information Services (EPCIS) data.

3. The method as claimed in claim 1, wherein the inventory dataset includes a unique identifier associated with each inventory item of the inventory storage facility.

4. The method as claimed in claim 3, wherein the inventory dataset includes hierarchical information of the products linked to each other in a parent-child relation such that the unique identifier of a parent product is linked to the unique identifiers of one or more child products associated with the parent product.

5. The method as claimed in claim 1, wherein the inventory dataset includes information pertaining to a status of the inventory at different instances.

6. The method as claimed in claim 1, wherein the aging inventory comprises at least one of:
an inventory for which an expiry date is approaching; and
an inventory which has been stored at the inventory storage facility beyond a pre-defined duration.

7. The method as claimed in claim 6, wherein the recommendation comprises:
for the inventory for which an expiration date is approaching, disposing the aging inventory as per First-Expiry-First-Out rule; and
for the inventory which has been stored beyond a pre-defined duration, disposing the aging inventory as per First-In-First-Out rule.

8. A system comprising:
a processor;
a query engine, coupled to the processor, to:
query a centralized repository to retrieve an inventory dataset associated with a product inventory stored in a plurality of associated inventory storage facilities, wherein the centralized repository stores the inventory dataset in a specific format;
a recommendation engine, coupled to the processor, to:
based on the inventory dataset, determine an expiration date of each item in the product inventory stored across all inventory storage facilities;
generate recommendations for taking a pre-determined action with respect to the product inventory stored across all facilities, based on the expiration date; and
update the inventory dataset in the centralized repository upon receiving a confirmation that the pre-determined action has been taken.

9. The system as claimed in claim 8, wherein an inventory storage facility comprises one of a warehouse, manufacturing unit, and a distribution unit associated with a supply chain.

10. The system as claimed in claim 8, wherein to generate recommendations, the recommendation engine is to determine if:
the expiration date of the product inventory has been crossed; or
the expiration date of the product inventory is approaching.

11. The system as claimed in claim 10, wherein if the expiration date of the product inventory is approaching, the recommendation engine is to generate recommendation to distribute the product inventory based on a First-Expiry-First-Out (FEFO) method.

12. The system as claimed in claim 11, wherein if the expiration date of the product inventory has been crossed, the recommendation engine is to generate alerts for each of the inventory storage facilities to discard the product inventory.

13. The system as claimed in claim 8, wherein a plurality of inventory datasets is stored in the centralized repository as an Electronic Product Code Information Services (EPCIS) data.

14. The system as claimed in claim 8, wherein the recommendation engine is to:
compute an age of the product inventory based on the expiration date; and
generate alerts for each inventory storage facility of the supply chain to indicate aging inventory.

15. The system as claimed in claim 8, wherein the recommendation engine is to initiate inventory replenishment to update a product inventory at the plurality of associated inventory storage facilities based on at least one of the recommendations and a user input.

16. A non-transitory computer-readable medium having instructions stored thereon, the instructions, when executed by a processor, cause the processor to perform operations comprising:
querying a centralized repository to access a plurality of inventory datasets associated with all products stored at a plurality of inventory storage facilities of multiple supply chains;
in response to querying, obtain one or more inventory datasets, from amongst the plurality of inventory datasets, of all products stored at the plurality of inventory storage facilities pertaining to a supply chain;
based on the one or more inventory datasets, computing an inventory holding period for all the products stored at the plurality of inventory storage facilities;
determining if the inventory holding period has exceeded a pre-defined duration, at one or more inventory storage facilities from amongst the plurality of inventory storage facilities; and
based on the determination, initiate distribution of the products from the plurality of inventory storage facilities, based on a set of rules.

17. The non-transitory computer-readable medium as claimed in claim 16, wherein the plurality of inventory datasets is stored in the centralized repository as an Electronic Product Code Information Services (EPCIS) data.

18. The non-transitory computer-readable medium as claimed in claim 16, wherein an inventory dataset of a product includes information pertaining to at least one of a manufacturing of the product, packaging of the product, unique identifier associated with the packaging, association between different packaging, and a status of the inventory at different instances.

19. The non-transitory computer-readable medium as claimed in claim 16, wherein the set of rules include rules for distributing the product inventories from the one or more inventory storage facilities as per First-In-First-Out (FIFO) rule.

20. The non-transitory computer-readable medium as claimed in claim 16, wherein the instructions, when executed by a processor, cause the processor to generate expiration alerts for the product inventories.
